(19) United States
(12) Patent Application Publication
(10) Pub. No.: US 2024/0430944 A1
(43) Pub. Date: Dec. 26, 2024

(54) RANDOM ACCESS PROCEDURES FOR LTM EXECUTION

(71) Applicant: Samsung Electronics Co., Ltd., Suwon-si (KR)

(72) Inventor: Donggun KIM, Staines (GB)

(21) Appl. No.: 18/734,237

(22) Filed: Jun. 5, 2024

(30) Foreign Application Priority Data
Jun. 20, 2023 (GB) 2309299.2
May 20, 2024 (GB) 2407168.0

(51) Int. Cl. H04W 74/0833

(52) U.S. Cl. CPC H04W 74/0833

(57) ABSTRACT

A method of transmitting a random access preamble in a telecommunication system is provided. The method includes, if the random access procedure is initiated by a physical downlink control channel (PDCCH) ordering for a layer 1 (L1)/layer 2 (L2)-triggered mobility (LTM) candidate cell as preamble re-transmission, and incrementing a variable, PREAMBLE_POWER_RAMPING_COUNTER, by 1.

### CROSS-REFERENCE TO RELATED APPLICATION(S)

This application is based on and claims priority under 35 U.S.C. § 119(a) of a United Kingdom patent application number 2309299.2, filed on Jun. 20, 2023, in the United Kingdom Intellectual Property Office, and of a United Kingdom patent application number 2407168.0, filed on May 20, 2024, in the United Kingdom Intellectual Property Office, the disclosure of each of which is incorporated by reference herein in its entirety.

### BACKGROUND

### 1. Field

The disclosure relates to layer 1 (L1)/layer 2 (L2)-triggered mobility (LTM) in a telecommunication network. More particularly, the disclosure relates to providing low latency, low complexity, and no user plane data loss. Various embodiments also consider the impacts on legacy behaviors, such that various embodiments incorporating a new LTM cell switch feature described herein does not conflict with them.

### 2. Description of Related Art

Fifth generation (5G) mobile communication technologies define broad frequency bands such that high transmission rates and new services are possible, and can be implemented not only in “Sub gigahertz (6 GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide layer 1 (L1)/layer 2 (L2)-triggered mobility (LTM) in a telecommunication network that provides low latency, low complexity, and no user plane data loss.

Additional aspects will be set forth in part in the description which follows and, in part, will be apparent from the description, or may be learned by practice of the presented embodiments.

In accordance with an aspect of the disclosure, a method of transmitting a random access preamble in a telecommunication system is provided. The method includes, ordering, if the random access procedure is initiated by a physical downlink control channel (PDCCH) for an LTM candidate cell as preamble re-transmission, and incrementing a variable, PREAMBLE_POWER_RAMPING_COUNTER, incremented by 1.

In an embodiment of the disclosure, computing, except for contention-free random access preamble for beam failure recovery request and contention-free random access preamble triggered by a PDCCH order for an LTM candidate cell, radio network temporary identifier (RNTI) for random access response (RAR) (RA-RNTI) associated with the physical random access channel (PRACH) occasion in which the random access preamble is transmitted.

In an embodiment of the disclosure, if the random access procedure is triggered by a PDCCH order for an LTM candidate cell, then the random access procedure is considered to be completed.

In accordance with another aspect of the disclosure, a method for performing a LTM cell switch by a user equipment (UE) communicatively coupled to a telecommunication network, configured with an LTM candidate cell configuration is provided. The method includes terminating a random access procedure by sending a preamble to the telecommunication network.

In an embodiment of the disclosure, if the random access procedure fails, the UE receives a PDCCH instruction from the network indicating whether the preamble is a first transmission or a retransmission, with the UE increasing a power ramping variable accordingly.

In an embodiment of the disclosure, the UE completes the LTM cell switch procedure by sending a RRCReconfigurationComplete message to the candidate cell.

In an embodiment of the disclosure, in a random access channel (RACH)-based LTM cell switch, the LTM cell switch is completed when the RACH is successfully completed.

In an embodiment of the disclosure, in a RACH-less based LTM cell switch, the LTM call switch is successfully completed when the UE determines that the network has successfully received its first uplink (UL) data.

In an embodiment of the disclosure, there is further provided the operation of checking hybrid automatic repeat request (HARQ) acknowledgment (ACK) or radio link control (RLC) ACK for the first uplink data.

In accordance with another aspect of the disclosure, a user equipment (UE) communicatively coupled to a telecommunication network, configured with an LTM candidate cell configuration, for performing a method of a layer 1 (L1)/layer 2 (L2)-triggered mobility (LTM) cell switch is provided. The UE includes memory storing one or more computer programs, one or more processors communicatively coupled to the memory, wherein the one or more computer programs include computer-executable instructions that, when executed by the one or more processors individually or collectively, cause the UE to terminate a random access procedure by sending a preamble to the telecommunication network.

In accordance with another aspect of the disclosure, one or more non-transitory computer-readable storage media storing computer-executable instructions that, when executed by one or more processors individually or collectively, cause a user equipment (UE) to perform operations are provided. The operations include terminating a random access procedure by sending a preamble to a telecommunication network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a signaling procedure for layer 1 (L1)/layer 2 (L2)-triggered mobility (LTM) according to an embodiment of the disclosure; and

FIG. 2 is a flowchart illustrating an LTM execution procedure in a wireless communication system according to an embodiment of the disclosure.

FIG. 3 illustrates a user equipment (UE) in a wireless communciation systems to which embodiments of the disclosure can be applied.

FIG. 4 illustrates a base station in a wireless communication system to which embodiments of the disclosure can be applied.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

LTM is a procedure in which a base station (gNB) receives L1 measurement reports from user equipments (UEs), and on their basis, the gNB changes UEs' serving cell(s) by a cell switch command through a medium access control (MAC) control element (CE), which indicates an LTM candidate cell configuration that the gNB previously prepared and provided to the UE through radio resource control (RRC) signaling. Thereafter, a cell switch is triggered by selecting the indicated LTM candidate cell configuration as the target configuration by the gNB. An LTM candidate cell configuration can only be added, modified, and released by network via RRC signaling. The LTM procedure can be used to reduce the mobility.

The following principles apply to LTM:
Each LTM candidate cell configuration can be provided as delta configuration on top of a reference configuration, which is used to form a complete candidate cell configuration. The reference configuration can be managed separately, and a UE stores the reference configuration as a separate configuration. The LTM candidate cell configuration can be configured in RRCReconfiguration message via SRB1 (e.g., signaling radio bearer), i.e., it can be configured after SRB1 establishment.
When a complete candidate cell configuration is applied, it replaces the current UE configuration at the time of cell switch. Although the reconfiguration procedure makes replacement, it does not necessarily reset MAC, RLC or packet data convergence protocol (PDCP) layer.
User plane is continued without reset to support lossless delivery of user plane data (e.g., intra-distributed unit (DU) LTM), if it is configured in RRC signaling, with the target to avoid data loss and the additional delay of data recovery. Specifically, indicators for RLC re-establishment or MAC reset (or partial MAC reset) or PDCP re-establishment or PDCP data recovery or service data unit (SDU) discard can be included in RRCReconfiguration message as listed below, which can be included with LTM candidate cell configuration together:
   a indicator for MAC reset or partial MAC reset included in RRCReconfiguration message (e.g., in cell group (or cell) configuration)
   a indicator for RLC re-establishment (e.g., reestablishRLC) included in RRCReconfiguration message (e.g., in cell group (or cell) configuration)
   a indicator for PDCP re-establishment (e.g., reestablishPDCP) included in RRCReconfiguration message (e.g., in radio bearer configuration, i.e., RadioBearerConfig IE)
   a indicator for PDCP data recovery (e.g., recoverPDCP) included in RRCReconfiguration message (e.g., in radio bearer configuration, i.e., RadioBearerConfig 1E)
a indicator for SDU discard (e.g., discardOnPDCP) for signaling radio bearers (SRBs) (e.g., SRB1 or SRB3) included in RRCReconfiguration message (e.g., in radio bearer configuration, i.e., RadioBearerConfig IE), which can be called PDCP SDU discard.
   The above indicators can be included in RRCReconfiguration message (e.g., in cell group configuration or LTM candidate cell configuration) including candidate cell configurations for LTM. Upon the reception of the RRCReconfiguration message, UE can store the cell configuration and the indicators and does not apply them to UE configuration. When UE successfully completes it after triggering the LTM procedure (or cell switch) by a cell switch command through a MAC CE indicating the target cell(s) (e.g., identifier(s)), beam index, or, timing advance (TA) value, UE can apply the LTM candidate cell configuration and the indicators corresponding to the target cell (or indicated cell in MAC CE). The following conditions are considered as successful completion of the LTM procedure (i.e., cell switch):
   For RACH-based LTM procedure (cell switch), the UE considers that LTM execution procedure is successfully completed when the RACH is successfully completed.
   For RACH-less LTM procedure (cell switch), the UE considers that LTM execution procedure is successfully complete when the UE determines the NW has successfully received its first UL data.
   When the above condition for successful completion of LTM cell switch is met (or the LTM cell candidate configuration is complete, i.e., if the LTM cell candidate configuration is indicated to be applied by an indicator), UE can apply the LTM candidate cell configuration and the indicators corresponding to the target cell (or indicated cell in MAC CE) to UE configuration. This approach can avoid UE's early application and reverting it back when it fails, which eases UE implementation. Moreover, the UE cannot know the time when the network sends MAC CE indicating LTM cell switch to UE.
   For example, when the above condition is met, UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate MAC reset (or partial MAC reset) to MAC layer, if configured.
   For example, when the above condition is met, UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate RLC re-establishment to RLC layer, if configured.
   For example, when the above condition is met, UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. When the condition is met, the MAC layer can indicate the successful completion of LTM cell switch to the RRC layer. The RRC layer can indicate PDCP re-establishment to PDCP layer, if configured.
   For example, when the above condition is met, UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with acknowledged mode (AM) mode). When the condition is met, the MAC layer can indicate the successful completion of LTM cell switch to the RRC layer. The RRC layer can indicate PDCP data recovery to PDCP layer, if configured.
   For example, when the above condition is met, UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with acknowledged mode (AM) mode). When the condition is met, the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity shall discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to).

In another embodiment of the disclosure, upon the reception of MAC CE indicating LTM cell switch (or LTM cell switch execution), UE can apply the LTM candidate cell configuration and the indicators corresponding to the target cell (or indicated cell in MAC CE) to UE configuration. This approach can avoid UE's early application and revert it back when it fails, which eases UE implementation. This approach can avoid UE's early application. As the UE cannot know the time when the network sends MAC CE indicating LTM cell switch, UE can follow this approach to apply the configuration timely. The reception of MAC CE indicating LTM cell switch can imply LTM cell switch execution.
For example, upon the reception of MAC CE indicating LTM cell switch (or LTM cell switch execution), UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.
For example, upon the reception of MAC CE indicating LTM cell switch (or LTM cell switch execution), UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate RLC re-establishment to RLC layer, if configured.
For example, upon the reception of MAC CE indicating LTM cell switch (or LTM cell switch execution), UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate PDCP re-establishment to PDCP layer, if configured.
For example, upon the reception of MAC CE indicating LTM cell switch (or LTM cell switch execution), UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with acknowledged mode (AM) mode). Upon the reception of MAC CE indicating LTM cell switch (or LTM cell switch execution), the MAC layer can indicate the successful completion of LTM cell switch to the RRC layer. The RRC layer can indicate PDCP data recovery to PDCP layer, if configured.
For example, upon the reception of MAC CE indicating LTM cell switch (or LTM cell switch execution), UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with acknowledged mode (AM) mode). Upon the reception of MAC CE indicating LTM cell switch (or LTM cell switch execution), the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity shall discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC reconfiguration complete message for the target cell UE failed to LTM cell switch to).

In another embodiment of the disclosure, upon the reception of MAC CE indicating LTM cell switch (or LTM cell switch execution) or upon the reception of RRCReconfiguration message including the indicators (or the LTM cell candidate configuration is complete, i.e., if the LTM cell candidate configuration is indicated to be applied by an indicator), UE can apply the LTM candidate cell configuration (e.g., complete LTM cell configuration) and the indicators corresponding to the target cell (or indicated cell in MAC CE) to UE configuration. This approach can be efficiently performed by the network. For example, the network sends MAC CE indicating LTM cell switch and RRCReconfiguration message including indicators together (e.g., at a time or in the same MAC PDU) to make UE perform the following actions.
For example, upon the reception of MAC CE indicating LTM cell switch (or LTM cell switch execution) or upon the reception of RRCReconfiguration message including the indicators, UE performs MAC reset (or partial MAC reset) if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of MAC CE indicating LTM cell switch (or LTM cell switch execution), the MAC layer can indicate the successful completion of LTM cell switch to the RRC layer. The RRC layer can indicate MAC reset (or partial MAC reset) to MAC layer, if configured.
For example, upon the reception of RRCReconfiguration message including the indicators, UE performs RLC re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate RLC re-establishment to RLC layer, if configured.
For example, upon the reception of RRCReconfiguration message including the indicators, UE performs PDCP re-establishment if the indicator is configured in the stored configuration (e.g., LTM candidate cell configuration for LTM) corresponding to the target cell (or indicated cell in MAC CE or successfully switched cell), which can be done by applying the complete LTM cell configuration. Upon the reception of RRCReconfiguration message including the indicators, the MAC layer can indicate the successful completion of LTM cell switch to the RRC layer. The RRC layer can indicate PDCP re-establishment to PDCP layer, if configured.
For example, upon the reception of RRCReconfiguration message including the indicators, UE performs PDCP data recovery if the indicator is configured in the stored configuration (e.g., LTM candidate cell configuration for LTM) corresponding to the target cell (or indicated cell in MAC CE or successfully switched cell), which can be done by applying the complete LTM cell configuration. PDCP data recovery can be configured only for a PDCP entity associated with AM RLC entities (RLC entity with acknowledged mode (AM) mode). Upon the reception of RRCReconfiguration message including the indicators, the MAC layer can indicate the successful completion of LTM cell switch to the RRC layer. The RRC layer can indicate PDCP data recovery to PDCP layer, if configured.
For example, upon the reception of RRCReconfiguration message including the indicators UE performs SDU discard in PDCP entity (i.e., PDCP SDU discard) if the indicator is configured in the stored configuration (e.g., LTM candidate cell configuration for LTM) corresponding to the target cell (or indicated cell in MAC CE or successfully switched cell), which can be done by applying the complete LTM cell configuration. SDU discard can be configured only for a PDCP entity of SRBs associated with AM RLC entities (RLC entity with acknowledged mode (AM) mode). Upon the reception of RRCReconfiguration message including the indicators, the MAC layer can indicate the successful completion of LTM cell switch to the RRC layer. The RRC layer can indicate SDU discard to PDCP layer, if configured. For SRBs, when upper layers (e.g., RRC layer) request a PDCP SDU discard, the PDCP entity shall discard all stored PDCP SDUs and PDCP PDUs. It is beneficial to discard old RRC messages of SRBs to prevent unnecessary (re-)transmission to the target cell. The PDCP SDU discard for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC Reconfiguration Complete message for the target cell UE failed to LTM cell switch to). The RLC re-establishment for SRBs (e.g., SRB1 or SRB3) can be triggered and performed when the LTM cell switch procedure fails (e.g., the supervisor timer for LTM cell switch is expired), in order to avoid unnecessary (re-)transmission of RRC message (e.g., RRC Reconfiguration Complete message for the target cell UE failed to LTM cell switch to)

NOTE: This delayed application of configuration is totally different from the legacy behavior because UE performs MAC reset/RLC/PDCP re-establishment, if configured, upon the reception of RRCReconfiguration in legacy procedure. In the above, the stored LTM candidate cell configuration can be regarded as reference configuration, which can be applied at a specific time as proposed.
Security is not updated in LTM. In another embodiment of the disclosure, the network decides whether to update the security based on the type of mobility (e.g., to which cell UE is indicated to perform cell switch). For example, the security configuration for security update is not included in the LTM candidate cell configuration (RRCReconfiguration) for the case that this candidate cell belongs to intra-gNB-DU or intra-gNB-centralized unit (CU). However, the security configuration for security update is included in the LTM candidate cell configuration (RRCReconfiguration) for the case that this candidate cell belongs to inter-gNB-DU (i.e., inter-gNB-DU mobility case) When the condition for successful completion of LTM cell switch is met after triggering the LTM procedure (or cell switch) by a cell switch command through a MAC CE, UE applies and updates the security configuration to the current configuration, if configured,
Subsequent LTM between LTM candidate cell configurations (i.e., UE does not release other LTM candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
Primary cell (PCell) change in non-carrier aggregation (CA) scenario,
PCell change without secondary cell (SCell) change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.
Dual connectivity scenario, at least for the primary secondary cell (PSCell) change without master node (MN) involvement case, i.e., intra-secondary node (SN). When UE is configured with dual connectivity (i.e., secondary cell group (SCG) and master cell group (MCG)), For SCG (or LTM procedure for SCG), the LTM candidate cell configuration of SCG can be configured in RRCReconfiguration message via SRB3, i.e., it can be configured after SRB3 establishment. For SCG (or LTM procedure for SCG), the LTM candidate cell configuration of SCG cannot be configured via SRB1. For MCG (or LTM procedure for MCG), the LTM candidate cell configuration of MCG can be configured in RRCReconfiguration message via SRB1, i.e., it can be configured after SRB1 establishment.

Cell switch trigger is conveyed in a MAC CE, which contains at least a candidate configuration index together with beam indication.

UE may perform contention based random access (CBRA) or contention free random access (CFRA) at cell switch. UE may also skip random access procedure (i.e., RACH-less solution) if UE does not need to acquire TA for the target cell during cell switch.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

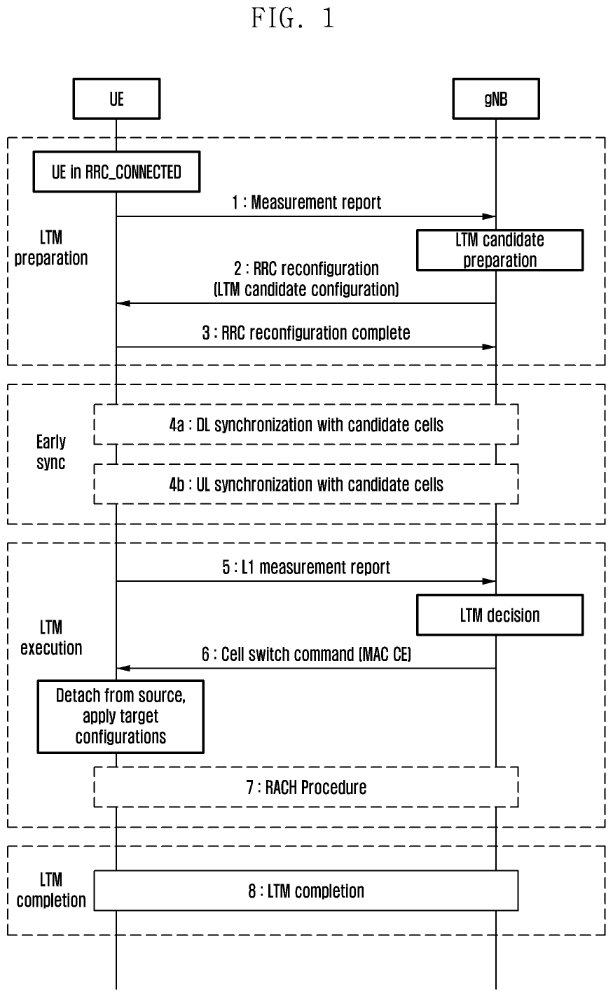

FIG. 1 illustrates a signaling procedure for LTM according to an embodiment of the disclosure.

Subsequent LTM is done by repeating the early synchronization, LTM execution, and LTM completion operations without releasing other LTM candidate cell configurations after each LTM completion.

Referring to FIG. 1, the procedure for LTM is as follows:

1. The UE sends a MeasurementReport message to the gNB. The gNB decides to use LTM and initiates candidate cell(s) preparation.

2. The gNB transmits an RRCReconfiguration message to the UE including the LTM candidate cell configurations of one or multiple candidate cells.

3. The UE stores the LTM candidate cell configurations and transmits a RRCReconfigurationComplete message to the gNB.

4a/4b. The UE may perform downlink (DL) synchronization and TA acquisition with candidate cell(s) before receiving the cell switch command.

Synchronization for candidate cell(s) before cell switch command is supported, at least based on synchronization signal block (SSB).

In an embodiment of this disclosure, TA acquisition of candidate cell(s) before LTM cell switch command is supported, is at least based on physical downlink control channel (PDCCH) ordered RACH, where the PDCCH order is only triggered by source cell. The source cell can trigger UE's random access procedure (RACH) toward a candidate cell by PDCCH order to acquire timing advance or timing advance value (TA) for the candidate cell, which only performs preamble transmission and does not expect the reception of random access response (RAR) to ease network implementation and UE implementation. Specifically, the preamble transmission during this random access procedure (RACH) for TA acquisition (i.e., early RACH) can be considered as this random access procedure is successfully completed. To reduce the processing complexity, UE does not have to calculate RA-RNTI (RNTI for random access response) before/when the preamble is transmitted, unlike normal random access procedure (RACH). To be more specific, UE transmits preamble to a candidate cell as indicated by PDCCH order. The network (or distributed unit (DU) or the candidate cell) calculates the timing advance (TA). The source cell/DU can get the calculated TA from the candidate cell/DU. By doing this random access procedure (RACH) for TA acquisition (i.e., early RACH), the network can have the TA values for the candidate cells and knows whether these TAs are still valid or not, e.g., by maintaining a network side timer (i.e., timeAlignmentTimer (TAT) for each TA value or each candidate cell). In this way, the source cell/DU gets to know the value and the validity of candidate cell TA. The source cell/DU needs to know whether a candidate cell TA is still valid because the source cell/DU needs to determine whether it can initiate a RACH-less solution for LTM cell switch and then determine whether it needs to include a beam indication (e.g., transmission configuration indicator (TCI) state) and TA information in the LTM MAC CE. Therefore, the network can indicate a valid TA to the UE or indicate whether a TA is still valid in LTM MAC CE. The UE may not need to maintain a TA timer for candidate cells, which simplifies UE implementation. Upon the reception of the TA information indicated in LTM MAC CE, the UE can apply the TA value and start the TA timer for the target LTM candidate cell upon LTM execution (i.e., LTM cell switch) and UE can perform LTM cell switch without random access procedure (i.e., with RACH-less solution) if TAT for the target LTM candidate cell is running (i.e., TA value is valid) or if Beam failure is not detected for the target LTM candidate cell, which means that UE can monitor PDCCH from the target LTM candidate cell or UE can use configured grants the first UL data transmission to the target cell for RACH-less LTM execution (LTM cell switch).

5. The UE performs L1 measurements on the configured candidate cell(s), and transmits lower-layer measurement reports to the gNB.

Note that the order of DL/UL sync (operation 4a/4b) and L1 measurement (operation 5) may be reversed.

6. The gNB decides to execute cell switch to a target cell, and transmits a MAC CE triggering cell switch by including the candidate configuration index of the target cell. The UE switches to the configuration of the target cell.

7. The UE performs random access procedure towards the target cell, if cell switch needs to include performing random access procedure.

8. The UE indicates successful completion of the cell switch towards the target cell.

The UE can perform the operations 4-8 multiple times for subsequent LTM cell switch based on the configuration provided in operation 2.

The following relates to user plane (UP) handling. In LTM, whether the UE performs partial or full MAC reset, re-establishes RLC, performs data recovery with PDCP during cell switch is explicitly controlled by the network through RRC signaling.

MAC/RLC re-establishment/PDCP data recovery/PDCP re-establishment (when configured)

Radio frequency (RF) retuning (e.g., needed for inter-frequency), baseband retuning

When a random access procedure is initiated, UE selects a set of random access resources and initializes the following parameters for the random access procedure according to the values configured by RRC for the selected set of random access resources:
preambleReceivedTargetPower: initial random access preamble power for 4-operation RA type;
powerRampingStep: the power-ramping factor;
msgA-PreamblePowerRampingStep: the power ramping factor for MSGA preamble;
ra-PreambleIndex: random access preamble;
ra-PreambleStartIndex: the starting index of random access preamble(s) for on-demand System Information (SI) request;
startPreambleForThisPartition: the first preamble associated with the set of random access resources applicable to the random access procedure;
preambleTransMax: the maximum number of random access preamble transmission;

The following UE variables are used for the random access procedure:
PREAMBLE_INDEX;
PREAMBLE_TRANSMISSION_COUNTER;
PREAMBLE_TRANSMISSION_COUNTER_LTM;
PREAMBLE_POWER_RAMPING_COUNTER;
PREAMBLE_POWER_RAMPING_COUNTER_LTM;
PREAMBLE_POWER_RAMPING_STEP;
PREAMBLE_RECEIVED_TARGET_POWER;
POWER_OFFSET_2STEP_RA;
MSGA_PREAMBLE_POWER_RAMPING_STEP.

In embodiments of this disclosure, a RACH-less solution is supported (i.e., LTM cell switch without random access procedure) when UE performs LTM procedure (e.g., LTM execution) by the first MAC CE (i.e., LTM triggering MAC CE). In RACH-less procedure, the UE needs a valid TA to send the first UL message during LTM execution procedure (i.e., LTM cell switch). To provide the TA with early RACH procedure (i.e., PDCCH-ordered Random Access procedure before the first MAC CE), PDCCH-ordered Random Access procedure without random access response (RAR) is provided.

When the random access procedure for TA acquisition of LTM candidate cell(s) is triggered/indicated by PDCCH order (e.g., by an indication), UE performs random access procedure, i.e., UE transmits the preamble to physical random access channel (PRACH) resource of the indicated LTM candidate cell(s) and complete the random access procedure, i.e., the preamble transmission during this random access procedure for TA acquisition (i.e., early RACH) can be considered as this random access procedure is successfully completed. The preamble or the PRACH resources can be indicated by PDCCH order or (pre-)configured by RRC message (e.g., RRCReconfiguration message). To reduce the processing complexity, the UE does not calculate RA-RNTI before/when the preamble is transmitted, unlike normal Random Access procedure (RACH). To enable this functionality, one of the following options can be implemented:
Option 1: In this option, the network can avoid another random access procedure during the random access procedures for TA acquisition (i.e., before the successful completion of TA acquisition). The first preamble transmission for TA acquisition may not be successful and the network can request preamble retransmission for TA acquisition. In this case, the UE increments the first variable (PREAMBLE_POWER_RAMPING_COUNTER), calculates the preamble received target power, and retransmits the preamble with a higher power than the first preamble. For example, if the random access procedure is not initiated by the PDCCH order for an LTM candidate cell as preamble re-transmission (or if the normal random access procedure is initiated or if the random access procedure is initiated for LTM execution (i.e., LTM cell switch)), UE sets the first variable to 1. In other words, if the random access procedure is initiated by the PDCCH order for an LTM candidate cell as preamble transmission, i.e., first transmission (or if the normal random access procedure is initiated or if the random access procedure is initiated for LTM execution (i.e., LTM cell switch)), UE sets the first variable to 1. If the random access procedure is initiated by the PDCCH order for an LTM candidate cell as preamble re-transmission, UE does not set the first variable to 1. If the random access procedure is initiated by the PDCCH order for an LTM candidate cell as preamble re-transmission, UE increments the first variable by 1. Based on this, UE can calculate the preamble received target power, and retransmit the preamble with the higher power than the first preamble. To achieve this, the following procedure can be implemented:

### Random Access Procedure Initialization.

When the random access procedure is initiated on a serving cell or to an LTM candidate cell (or if the random access procedure is initiated for LTM execution (i.e., LTM cell switch) or if the random access procedure is initiated for TA acquisition for an LTM candidate cell), the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1, if the random access procedure is not initiated by the PDCCH order for an LTM candidate cell (i.e., for TA acquisition of the cell) as preamble re-transmission;

### Random Access Preamble Transmission

The MAC entity shall, for each random access preamble:
1> if PREAMBLE_TRANSMISSION_COUNTER is greater than one; and
1> if the notification of suspending power ramping counter has not been received from lower layers; and
1> if listen before talk (LBT) failure indication was not received from lower layers for the last random access preamble transmission; and
1> if SSB or channel state information reference signal (CSI-RS) selected is not changed from the selection in the last random access preamble transmission:
2> increment PREAMBLE_POWER_RAMPING_COUNTER by 1.
> if the random access procedure is initiated by the PDCCH order for an LTM candidate cell (i.e., for TA acquisition of the cell) as preamble re-transmission:
2> increment PREAMBLE_POWER_RAMPING_COUNTER by 1.
1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA;
> except for contention-free random access preamble for beam failure recovery request and random access preamble for an LTM candidate cell by the PDCCH-ordered random access procedure (i.e., for TA acquisition of the cell), compute the RA-RNTI associated with the PRACH occasion in which the random access preamble is transmitted; (UE does not have to compute the RA-RNTI associated with the PRACH occasion in which the random access preamble is transmitted if random access preamble is transmitted by PDCCH order for TA acquisition of the LTM candidate cell because the reception of RAR is not expected. However, UE computes the RA-RNTI associated with the PRACH occasion in which the random access preamble is transmitted, for normal random access procedure or random access procedure for LTM execution (i.e., LTM cell switch).
1> instruct the physical layer to transmit the random access preamble using the selected PRACH occasion, corresponding RA-RNTI (if available), PREAMBLE_INDEX, and PREAMBLE_RECEIVED_TARGET_POWER.
1> if the random access procedure is triggered by a PDCCH order for a LTM candidate cell (i.e., for TA acquisition of the cell): (The preamble transmission during this random access procedure for TA acquisition (i.e., early RACH) can be considered as this random access procedure is successfully completed)
2> consider this random access procedure successfully completed (or consider this random access response reception successful).
Option 2: In this option, the network can allow another random access procedure during the random access procedures for TA acquisition (i.e., before the successful completion of TA acquisition) by introducing the second variable (PREAMBLE_POWER_RAMPING_COUNTER_LTM). It can be also be extended to support TA acquisition for multiple LTM candidates by having the second variable per LTM candidate cell. The first preamble transmission for TA acquisition may not be successful and the network can request preamble retransmission for TA acquisition. In this case, the UE increments the second variable, calculates the preamble received target power, and retransmit the preamble with the higher power than the first preamble. For example, if the random access procedure is not initiated by the PDCCH order for an LTM candidate cell as preamble re-transmission, UE sets the second variable to 1. In other words, if the random access procedure is initiated by the PDCCH order for an LTM candidate cell as preamble transmission, UE sets the second variable to 1. If the random access procedure is initiated by the PDCCH order for an LTM candidate cell as preamble re-transmission, UE does not set the second variable to 1. If the random access procedure is initiated by the PDCCH order for an LTM candidate cell as preamble re-transmission, UE increments the second variable by 1. Based on this, UE can calculate the preamble received target power, and retransmit the preamble with the higher power than the first preamble. However, if the normal random access procedure is initiated or if the random access procedure is initiated for LTM execution (i.e., LTM cell switch), UE sets the first variable to 1. In other words, if the normal random access procedure is initiated or if the random access procedure is initiated for LTM execution (i.e., LTM cell switch), UE sets the first variable to 1. If the random access procedure is initiated by the PDCCH order for an LTM candidate cell as preamble re-transmission, UE does not set the first variable to 1. if PREAMBLE_TRANSMISSION_COUNTER is greater than one, and if the notification of suspending power ramping counter has not been received from lower layers; and if LBT failure indication was not received from lower layers for the last random access preamble transmission and if SSB or CSI-RS selected is not changed from the selection in the last random access preamble transmission, UE increments the first variable by 1. Based on this, UE can calculate the preamble received target power, and retransmit the preamble with the higher power than the first preamble. To achieve this, the following procedure can be implemented (In another embodiment of the disclosure, the first variable can be reused as the second variable):

### Random Access Procedure Initialization

When the random access procedure is initiated on a serving cell (or when the random access procedure is initiated for LTM execution (i.e., LTM cell switch) (and if the random access procedure is not initiated on a serving cell towards an LTM candidate cell (for TA acquisition of the LTM candidate cell by a PDCCH order including indications), the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;

When the random access procedure is initiated on a serving cell towards an LTM candidate cell (for TA acquisition of the LTM candidate cell by a PDCCH order including indications, e.g., LTM candidate cell identity, TA acquisition, preamble, PRACH resource, or the like), the MAC entity shall:
1> flush the Msg3 buffer;
1> flush the MSGA buffer;
1> set the PREAMBLE_TRANSMISSION_COUNTER_LTM to 1;
1> set the PREAMBLE_POWER_RAMPING_COUNTER_LTM to 1 (or set the PREAMBLE_POWER_RAMPING_COUNTER_LTM for the LTM candidate cell to 1), if the random access procedure is not initiated by the PDCCH order for an LTM candidate cell (i.e., for TA acquisition of the cell) as preamble re-transmission, (PREAMBLE_POWER_RAMPING_COUNTER_LTM can be set to 1 if the random access procedure is initiated by the PDCCH order for an LTM candidate cell (i.e., for TA acquisition of the cell) as preamble transmission (i.e., first transmission) or if LTM execution is successfully completed or upon the reception of the first MAC CE (i.e., LTM triggered MAC CE).

### Random Access Preamble Transmission

The MAC entity shall, for each random access preamble:
1> if PREAMBLE_TRANSMISSION_COUNTER is greater than one; and
1> if the notification of suspending power ramping counter has not been received from lower layers; and
1> if LBT failure indication was not received from lower layers for the last random access preamble transmission; and
1> if SSB or CSI-RS selected is not changed from the selection in the last random access preamble transmission:
2> increment PREAMBLE_POWER_RAMPING_COUNTER by 1.
1> if the random access procedure is initiated by the PDCCH order for an LTM candidate cell (i.e., for TA acquisition of the cell) as preamble re-transmission:
2> increment PREAMBLE_POWER_RAMPING_COUNTER_LTM by 1 (or increment PREAMBLE_POWER_RAMPING_COUNTER_LTM for the LTM candidate cell by 1.
1> select the value of DELTA_PREAMBLE;
1> set PREAMBLE_RECEIVED_TARGET_POWER to preambleReceivedTargetPower+DELTA_PREAMBLE+(PREAMBLE_POWER_RAMPING_COUNTER_LTM−1)×PREAMBLE_POWER_RAMPING_STEP+POWER_OFFSET_2STEP_RA, if the random access procedure is initiated by the PDCCH order for an LTM candidate cell (i.e., for TA acquisition of the cell);
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA if the random access procedure is not initiated by the PDCCH order for an LTM candidate cell (i.e., for TA acquisition of the cell);
1> except for contention-free random access preamble for beam failure recovery request and random access preamble for an LTM candidate cell by the PDCCH-ordered random access procedure (i.e., for TA acquisition of the cell), compute the RA-RNTI associated with the PRACH occasion in which the random access preamble is transmitted, (UE does not have to compute the RA-RNTI associated with the PRACH occasion in which the random access preamble is transmitted if random access preamble is transmitted by PDCCH order for TA acquisition of the LTM candidate cell because the reception of RAR is not expected. However, UE computes the RA-RNTI associated with the PRACH occasion in which the random access preamble is transmitted, for normal random access procedure or random access procedure for LTM execution (i.e., LTM cell switch).
1> instruct the physical layer to transmit the random access preamble using the selected PRACH occasion, corresponding RA-RNTI (if available), PREAMBLE_INDEX, and PREAMBLE_RECEIVED_TARGET_POWER.
1> if the random access procedure is triggered by a PDCCH order for a LTM candidate cell (i.e., for TA acquisition of the cell): (the preamble transmission during this random access procedure for TA acquisition (i.e., early RACH) can be considered as this random access procedure is successfully completed)
2> consider this random access procedure successfully completed (or consider this random access response reception successful);

### Completion of Random Access Procedure.

It would be beneficial to have cross-layer interaction between MAC layer and RRC layer to make RRC layer perform RRC-specific behaviors (e.g., stop the supervisor timer for LTM execution procedure).

Upon completion of the random access procedure, the MAC entity shall:
1> discard any explicitly signaled contention-free random access resources for 2-operation RA type and 4-operation RA type except the 4-operation RA type contention-free random access resources for beam failure recovery request, if any;
flush the HARQ buffer used for transmission of the MAC PDU in the Msg3 buffer and the MSGA buffer.

Upon successful completion of the random access procedure initiated for DAPS handover, the target MAC entity shall:
1> indicate the successful completion of the random access procedure to the upper layers.

Upon successful completion of the random access procedure initiated for LTM execution (or LTM cell switch or LTM execution procedure or by the reception of the first MAC CE), the MAC entity shall:
1> indicate the successful completion of the random access procedure (or the LTM execution procedure) to the upper layers.

Upon successful completion of the LTM execution procedure initiated for LTM execution (or LTM cell switch or by the reception of the first MAC CE), the MAC entity shall:
1> indicate the successful completion of the LTM execution procedure to the upper layers.

For RACH-based LTM execution procedure (i.e., LTM execution procedure with random access procedure), the UE considers that LTM execution procedure is successfully completed when the RACH is successfully completed.

For RACH-less LTM execution procedure (i.e., LTM execution procedure without random access procedure), the UE considers that LTM execution procedure is successfully completed when the UE determines that the network has successfully received its first UL data (e.g., by checking HARQ ACK or RLC ACK for the first UL data).

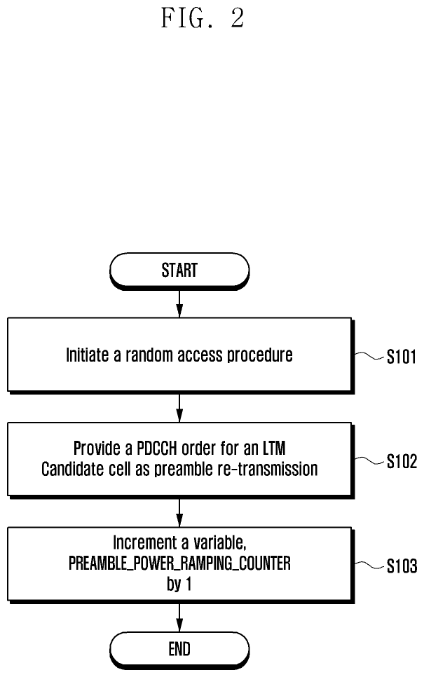

FIG. 2 is a flowchart illustrating an LTM execution procedure in a wireless communication system an embodiment according to an embodiment of the disclosure.

Referring to FIG. 2, at operation S101, a random access procedure is initiated. At operation 8102, a physical downlink control channel (PDCCH) order is provided for an LTM candidate cell as preamble re-transmission. At operation S103, a variable, PREAMBLE_POWER_RAMPING_COUNTER, is incremented by 1.

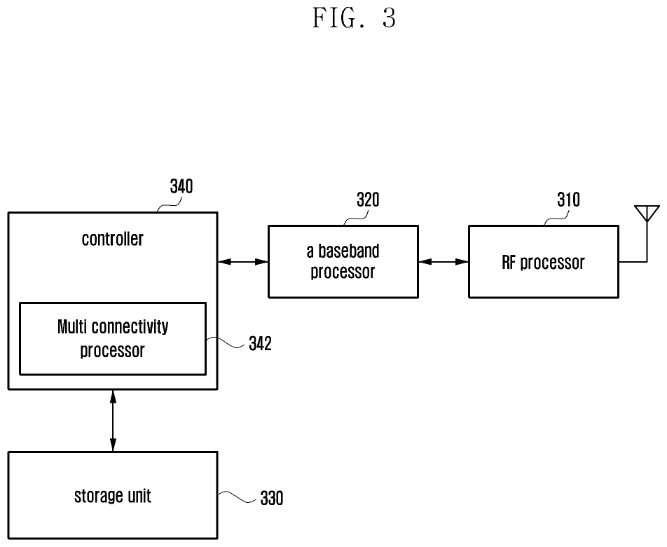

The structure of the UE to which embodiments of the disclosure can be applied is illustrated in FIG. 3.

Referring to FIG. 3, the UE includes a radio frequency (RF) processor 310, a baseband processor 320, a storage unit 330, and a controller 340.

The RF processor 310 performs a function for transmitting and receiving a signal through a wireless channel, such as band conversion and amplification of a signal. That is, the RF processor 310 up-converts a baseband signal provided from the baseband processor 320 into an RF band signal, transmits the RF band signal through an antenna, and then down-converts the RF band signal received through the antenna into a baseband signal. For example, the RF processor 310 may include a transmission filter, a reception filter, an amplifier, a mixer, an oscillator, a digital-to-analog converter (DAC), an analog-to-digital converter (ADC), and the like. Although FIG. 3 illustrates only one antenna, the UE may include a plurality of antennas. In addition, the RF processor 310 may include a plurality of RF chains. Moreover, the RF processor 310 may perform beamforming. For the beamforming, the RF processor 310 may control a phase and a size of each signal transmitted/received through a plurality of antennas or antenna elements. The RF processor may perform MIMO and receive a plurality of layers when performing the MIMO operation. The RF processor 310 may appropriately configure a plurality of antennas or antenna elements according to the control of the controller to perform reception beam sweeping or control a direction of a reception beam and a beam width so that the reception beam corresponds to a transmission beam.

The baseband processor 320 performs a function for a conversion between a baseband signal and a bitstream according to a physical layer standard of the system. For example, when data is transmitted, the baseband processor 320 generates complex symbols by encoding and modulating a transmission bitstream. Further, when data is received, the baseband processor 320 reconstructs a reception bitstream by demodulating and decoding a baseband signal provided from the RF processor 310. For example, in an orthogonal frequency division multiplexing (OFDM) scheme, when data is transmitted, the baseband processor 320 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 320 divides the baseband signal provided from the RF processor 310 in the unit of OFDM symbols, reconstructs the signals mapped to the subcarriers through a fast Fourier transform (FFT) operation, and then reconstructs a reception bitstream through demodulation and decoding.

The baseband processor 320 and the RF processor 310 transmit and receive signals as described above. Accordingly, the baseband processor 320 and the RF processor 310 may be referred to as a transmitter, a receiver, a transceiver, or a communication unit. Further, at least one of the baseband processor 320 and the RF processor 310 may include a plurality of communication modules to support a plurality of different radio access technologies. In addition, at least one of the baseband processor 320 and the RF processor 310 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 330 stores data such as basic program, an application, and setting information for the operation of the UE. The storage unit 330 provides the stored data according to a request from the controller 340.

The controller 340 controls the overall operation of the UE. For example, the controller 340 transmits/receives a signal through the baseband processor 320 and the RF processor 310. In addition, the controller 340 may record data in the storage unit 330 and read the data. To this end, the controller 340 may include at least one processor. For example, the controller 340 may include a communication processor (CP) that performs a control for communication, and an application processor (AP) that controls a higher layer such as an application program.

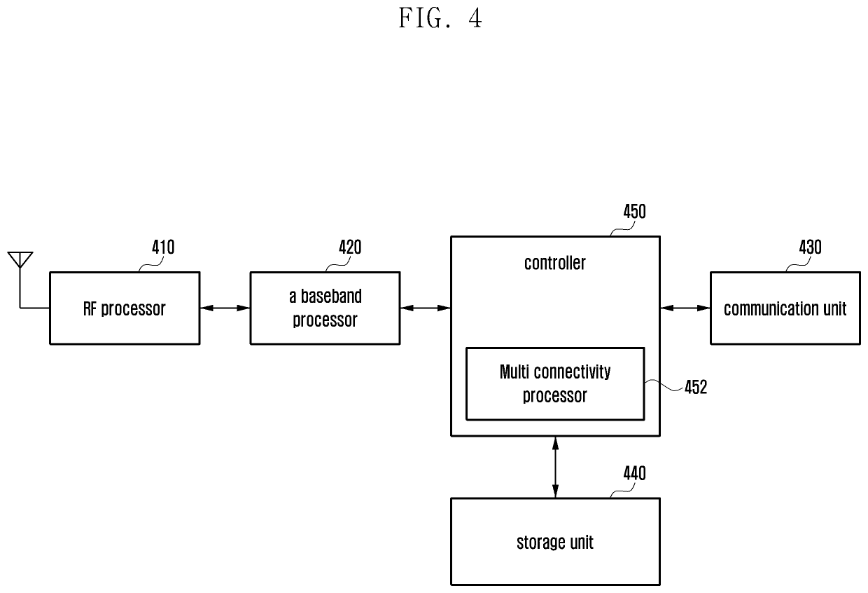

FIG. 4 illustrates a base station in a wirreless communication system to which embodiments of the disclosure can be applied.

As illustrated in FIG. 4, the base station includes an RF processor 410, a baseband processor 420, a backhaul communication unit 430, a storage unit 440, and a controller 450.

The RF processor 410 performs a function for transmitting and receiving a signal through a wireless channel, such as band conversion and amplification of a signal. That is, the RF processor 410 up-converts a baseband signal provided from the baseband processing unit 420 into an RF band signal and then transmits the converted signal through an antenna, and down-converts an RF band signal received through the antenna into a baseband signal. For example, the RF processor 410 may include a transmission filter, a reception filter, an amplifier, a mixer, an oscillator, a DAC, and an ADC. Although FIG. 4 illustrates only one antenna, the first access node may include a plurality of antennas. In addition, the RF processor 410 may include a plurality of RF chains. Moreover, the RF processor 410 may perform beamforming. For the beamforming, the RF processor 410 may control a phase and a size of each of the signals transmitted and received through a plurality of antennas or antenna elements. The RF processor may perform a downlink MIMO operation by transmitting one or more layers.

The baseband processor 420 performs a function of performing conversion between a baseband signal and a bitstream according to a physical layer standard of the first radio access technology. For example, when data is transmitted, the baseband processor 420 generates complex symbols by encoding and modulating a transmission bitstream. Further, when data is received, the baseband processor 420 reconstructs a reception bitstream by demodulating and decoding a baseband signal provided from the RF processor 410. For example, in an OFDM scheme, when data is transmitted, the baseband processor 420 may generate complex symbols by encoding and modulating the transmission bitstream, map the complex symbols to subcarriers, and then configure OFDM symbols through an IFFT operation and CP insertion. In addition, when data is received, the baseband processor 420 divides a baseband signal provided from the RF processor 410 in units of OFDM symbols, recovers signals mapped with sub-carriers through an FFT operation, and then recovers a reception bitstream through demodulation and decoding. The baseband processor 420 and the RF processor 410 transmit and receive signals as described above. Accordingly, the baseband processor 420 and the RF processor 410 may be referred to as a transmitter, a receiver, a transceiver, or a communication unit.

The communication unit 430 provides an interface for communicating with other nodes within the network.

The storage unit 440 stores data such as a basic program, an application, and setting information for the operation of the MeNB. Particularly, the storage unit 440 may store information on bearers allocated to the accessed UE and the measurement result reported from the accessed UE. Further, the storage unit 440 may store information on a reference for determining whether to provide multiple connections to the UE or stop the multiple connections. In addition, the storage unit 440 provides data stored therein according to a request from the controller 450.

The controller 450 controls the overall operation of the MeNB. For example, the controller 450 transmits and receives a signal through the baseband processor 420 and the RF processor 410 or through the backhaul communication unit 430. In addition, the controller 450 may record data in the storage unit 440 and read the data. To this end, the controller 450 may include at least one processor.

Although the present disclosure has been described with various embodiments, various changes and modifications may be suggested to one skilled in the art. It is intended that the present disclosure encompass such changes and modifications as fall within the scope of the appended claims.

At least some of the example embodiments described herein may be constructed, partially or wholly, using dedicated special-purpose hardware. Terms, such as ‘component’, ‘module’ or ‘unit’ used herein may include, but are not limited to, a hardware device, such as circuitry in the form of discrete or integrated components, a field programmable gate array (FPGA) or application specific integrated circuit (ASIC), which performs certain tasks or provides the associated functionality. In some embodiments of the disclosure, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment of the disclosure, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) supporting a layer 1/layer 2 (L1/L2) triggered mobility (LTM) in a wireless communication system, the method comprising:
receiving, from a base station, a radio resource control (RRC) message including LTM candidate cell configuration information;
identifying whether a random access procedure is triggered by a physical downlink control channel (PDCCH) order; and
in case that the random access procedure is triggered by the PDCCH order, transmitting, to a LTM candidate cell, a random access preamble based on the LTM candidate cell configuration information,
wherein the random access procedure is considered as completed based on the transmission of the random access preamble.

2. The method of claim 1,
wherein the UE does not receive a random access response from the base station, and
wherein the UE does not compute a random access-radio network temporary identifier (RA-RNTI) for the random access preamble.

3. The method of claim 1, the method further comprising:
transmitting, to the base station, a L1 measurement report;
receiving, from the base station, a LTM cell switch command including timing advance (TA) information associated with a target cell; and
based on the LTM cell switch command, switching to the target cell.

4. The method of claim 1, the method further comprising:
in case that the random access procedure triggered by the PDCCH order is associated with an initial transmission, setting a preamble power ramping counter to 1.

5. The method of claim 1, the method further comprising:
in case the random access procedure triggered by the PDCCH order is associated with a re-transmission, increasing the preamble power ramping counter by 1.

6. The method of claim 1,
wherein in case of a random access channel (RACH)-less LTM, a LTM cell switch procedure is considered as successfully completed when the UE determines that the base station has successfully received first uplink (UL) data.

7. A method performed by a base station a layer 1/layer 2 (L1/L2) triggered mobility (LTM) in a wireless communication system, the method comprising:
transmitting, to a user equipment (UE), a radio resource control (RRC) message including LTM candidate cell configuration information; and
in case that a random access procedure is triggered by a physical downlink control channel (PDCCH) order, receiving, from the UE, a random access preamble based on the LTM candidate cell configuration information,
wherein the random access procedure is considered as completed based on the reception of the random access preamble.

8. The method of claim 7,
wherein the base station does not transmit a random access response to the UE, and
wherein a random access-radio network temporary identifier (RA-RNTI) for the random access preamble is not computed.

9. The method of claim 7, the method further comprising:
receiving, from the UE, a L1 measurement report; and
transmitting, to the UE, a LTM cell switch command including timing advance (TA) information associated with a target cell.

10. The method of claim 7,
wherein in case that the random access procedure triggered by the PDCCH order is associated with an initial transmission, a preamble power ramping counter is set to 1, and
wherein in case that the random access procedure triggered by the PDCCH order is associated with a re-transmission, the preamble power ramping counter is increased by 1.

11. A user equipment (UE) supporting a layer 1/layer 2 (L1/L2) triggered mobility (LTM) in a wireless communication system, the UE comprising:
a transceiver; and
a controller configured to:
receive, from a base station, a radio resource control (RRC) message including LTM candidate cell configuration information,
identify whether a random access procedure is triggered by a physical downlink control channel (PDCCH) order, and
in case that the random access procedure is triggered by the PDCCH order, transmitting, to a LTM candidate cell, a random access preamble based on the LTM candidate cell configuration information,
wherein the random access procedure is considered as completed based on the transmission of the random access preamble.

12. The UE of claim 11,
wherein the UE does not receive a random access response from the base station, and
wherein the UE does not compute a random access-radio network temporary identifier (RA-RNTI) for the random access preamble.

13. The UE of claim 11, wherein the controller is further configured to:
transmit, to the base station, a L1 measurement report,
receive, from the base station, a LTM cell switch command including timing advance (TA) information associated with a target cell, and
based on the LTM cell switch command, switch to the target cell.

14. The UE of claim 11, wherein the controller is further configured to:
in case that the random access procedure triggered by the PDCCH order is associated with an initial transmission, set a preamble power ramping counter to 1.

15. The UE of claim 11, wherein the controller is further configured to:
in case the random access procedure triggered by the PDCCH order is associated with a re-transmission, increasing the preamble power ramping counter by 1.

16. The UE of claim 11,
wherein in case of a random access channel (RACH)-less LTM, a LTM cell switch procedure is considered as successfully completed when the UE determines that the base station has successfully received first uplink (UL) data.

17. A base station a layer 1/layer 2 (L1/L2) triggered mobility (LTM) in a wireless communication system, the base station comprising:
a transceiver; and
a controller configured to:
transmit, to a user equipment (UE), a radio resource control (RRC) message including LTM candidate cell configuration information, and
in case that a random access procedure is triggered by a physical downlink control channel (PDCCH) order, receive, from the UE, a random access preamble based on the LTM candidate cell configuration information,
wherein the random access procedure is considered as completed based on the reception of the random access preamble.

18. The base station of claim 17,
wherein the base station does not transmit a random access response to the UE, and
wherein a random access-radio network temporary identifier (RA-RNTI) for the random access preamble is not computed.

19. The base station of claim 17, wherein the controller is further configured to:
receive, from the UE, a L1 measurement report; and
transmit, to the UE, a LTM cell switch command including timing advance (TA) information associated with a target cell.

20. The base station of claim 17,
wherein in case that the random access procedure triggered by the PDCCH order is associated with an initial transmission, a preamble power ramping counter is set to 1, and
wherein in case that the random access procedure triggered by the PDCCH order is associated with a re-transmission, the preamble power ramping counter is increased by 1.
